(19) United States
(12) Patent Application Publication
(10) Pub. No.: US 2003/0014960 A1
(43) Pub. Date: Jan. 23, 2003

(54) Impulse turbine for rotary ramjet engine

(75) Inventor: Shawn P. Lawlor, Redmond, WA (US)

Correspondence Address: R REAMS GOODLOE JR, 10725 SE 256TH STREET, SUITE 3, KENT, WA, 980316426

(73) Assignee: RAMGEN POWER SYSTEMS, INC.

(21) Appl. No.: 09/912,172

(22) Filed: Jul. 23, 2001

(51) Int. Cl. F02K 7/10

(52) U.S. Cl. 60/39.35; 60/767

(57) ABSTRACT

A rotary ramjet engine generator set with impulse turbine. A rotary ramjet engine is provided operating with a very low axial flow component. The engine has a closely housed rotor and shaft mounted for rotary motion with respect to an engine case. An impulse turbine is mechanically coupled on a common shaft with a rotary ramjet engine. By properly setting the turbine rotating speed with respect to ramjet rotor rotating speed, the kinetic energy of the exhaust gas from the ramjet engine is efficiently captured by the turbine. In one embodiment, the turbine is mechanically coupled, via a planetary gear set, to the output shaft of the rotary ramjet engine. The impulse turbine includes a disc to which turbine blades are affixed, and an annular housing which connects the annular disc with a central body having a circular ring gear on the inside wall thereof. The ring gear meshingly engages a plurality of planetary gears, each of which are fixed with respect to the engine casing of the rotary ramjet engine. The planetary gears reverse the direction of rotation and thus redirect power received from the ring gear to a sun gear affixed to, or splined on, or provided integrally with, an output shaft of the rotary ramjet engine. By selection of an appropriate gear ratio, the relatively slower rotating impulse turbine has its rotational energy transferred to the output shaft at the design output shaft rate of rotation.

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention is related to rotary ramjet engines and their components and particularly to the use of turbines for extraction of additional energy from exhaust gases leaving such engines. Such rotary ramjet engines are particularly useful for generation of electrical and mechanical power at efficiencies substantially improved over power plants currently in widespread commercial use.

### BACKGROUND

A continuing demand exists for a simple, highly efficient and inexpensive power plant that can reliably provide electrical and mechanical power. A variety of small to medium size electrical and/or mechanical power plant applications could substantially benefit from a prime mover that provides a significant improvement from the currently known net efficiencies. Specifically, improved efficiency is increasingly important as fuel costs continue to rise. Such small to medium size mechanical or electrical power plants—typically but not exclusively from about 1 megawatt up to as much as about 100 megawatts—are required in a wide range of industrial applications, including stationary electric power generating units, in rail locomotives, and in marine power systems. Power plants in this general size range are well suited to use in industrial and utility electrical generation and cogeneration facilities. Such equipment is often employed to provide prime movers for electrical power needs while simultaneously supplying thermal energy to an industrial facility. Increasingly, such equipment is used to provide stand-alone merchant electric power production facilities.

Power plant designs which are now commonly utilized in such applications include (a) gas turbines, driven by the combustion of natural gas, fuel oil, or other fuels, and which capture the kinetic energy from the exiting combustion gases, (b) steam turbines, driven by the expansion of steam that is generated by heat recovery steam generators at gas turbine facilities, or by the expansion of steam generated in stand alone facilities from boilers via the combustion of coal, fuel oil, natural gas, solid waste, or other fuels, and (c), from large scale reciprocating engines, usually diesel cycle and typically fired with fuel oils.

Of the currently available power plant technologies, diesel fueled reciprocating engines and advanced gas turbine engines have the highest efficiency levels. Gas turbines perform more reliably than reciprocating engines, and are therefore frequently employed in plants that have higher power output levels. However, because gas turbines are only moderately efficient in converting fuel to electrical energy, gas turbine powered plants are most effectively employed in co-generation systems where both electrical and thermal energy can be utilized. In that way, the moderate efficiency of a gas turbine can, in part, be counterbalanced by increasing the overall cycle efficiency with the use of exhaust heat extraction techniques.

Because of their modest efficiency in conversion of fuel input to electrical output, the most widely used types of power plants, namely gas turbines and combustion powered steam turbine systems, often depend upon cogeneration in industrial settings in order to achieve acceptable costs of production of electricity. Therefore, it can be appreciated that it would be desirable to reduce costs of electrical production by generating electrical power at higher overall efficiency rates than is commonly achieved today.

### SUMMARY

We have now invented, and disclose herein various embodiments and aspects of technology for the application of a turbine in combination with a rotary ramjet power plant. A power plant design, involving the use of a ramjet engine as the prime mover, has higher overall cycle efficiencies when compared to those heretofore-used power plants of which we are aware. Compared to many power plants commonly in use today, such a power plant design is simple, more compact, relatively inexpensive, easier to install and to service, and/or otherwise superior to currently operating plants of which we are aware.

To even further enhance the efficiency of such power plants, a unique turbine design has been developed in which the turbine is mechanically coupled on a common shaft with a rotary ramjet engine. By properly setting the turbine rotating speed with respect to ramjet rotor rotating speed, the kinetic energy of the exhaust gas from the ramjet engine is efficiently captured by the turbine. More specifically, in a preferred embodiment, the turbine can be mechanically coupled, via a planetary gear set, to the output shaft of the rotary ramjet engine, thus eliminating the need to capture its power output via a separate, external gear and/or electrical generation device. The common shaft mounted turbine is beneficial commercially because it enables a power plant to avoid additional separate power output or generation equipment, yet captures otherwise discarded kinetic energy from the exhaust gases, thus increasing overall efficiency.

In one embodiment of the planetary gear configuration, an impulse turbine includes a disc to which turbine blades are affixed, and an annular housing which connects the annular disc with a central body having a circular ring gear on the inside wall thereof. The ring gear meshingly engages a plurality of planetary gears, each of which are fixed with respect to the engine casing of the rotary ramjet engine. The planetary gears reverse the direction of rotation and thus redirect power received from the ring gear to a sun gear affixed to, or splined on, or provided integrally with, an output shaft of the rotary ramjet engine. By selection of impulse turbine speed, based on the rotary ramjet engine operating parameters, an appropriate gear ratio may be selected, so that a relatively slow impulse turbine has its rotational energy transferred to the output shaft at the design output shaft rate of rotation. A combustion exhaust gas duct may be used to collect and discharge the hot exhaust gas stream to a conduit for transport to a heat exchanger, where the hot exhaust gases are cooled by way of heating up a heat transfer fluid, such as water, in which case the production of hot water or steam results. The heat transfer fluid may be utilized for thermal purposes, or for mechanical purposes, such as driving a steam turbine. In any event, ultimately, the cooled combustion gases are exhausted to the ambient air. Optionally, a set of steam buckets may also be included with the impulse turbine, in order to additionally collect and utilize, on the same wheel as the impulse turbine, energy provided by the expansion of steam that was generated utilizing exhaust heat from the rotary ramjet engine.

Further, variations in the impulse turbine arrangement, or in the simultaneous use of exhaust gases and of steam for driving a turbine wheel, may be made by those skilled in the art without departing from the teachings hereof.

### OBJECTS, ADVANTAGES, AND FEATURES OF THE INVENTION

From the foregoing, it will be apparent to the reader that one object of the present invention resides in the provision of a rotary ramjet engine to generate mechanical and/or electrical power.

More specifically, this object may be advanced by providing a ramjet driven power generation plant which is capable of reliably and efficiently recovering kinetic energy from exiting combustion gases

Other objects of the various embodiments and aspects of the invention reside in the provision of rotary ramjet engine driven power generation plants as described in the preceding paragraph which:

have efficient turbines for kinetic energy recovery from the ramjet exhaust system;

has an turbine gearbox design that allows moderate gear operational speeds, even when the ramjet engine rotates at very high tip speeds;

which enable the direct power transfer from the turbine to the high speed shaft at a desired high speed output shaft rotational speed.

have high efficiency rates; that is, provides a high work output relative to the heating value of fuel input to the power plant;

allow the generation of power to be done in a simple, direct manner;

require less physical space than existing technology power plants;

are easy to construct, to start, and to service;

Other important objects, features, and additional advantages of the various embodiments and aspects of the invention will become apparent to those skilled in the art from the foregoing and from the detailed description that follows and the appended claims, in conjunction with the accompanying drawing.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

FIG. 1 provides a partial cross-sectional view of the rotating assembly of an exemplary power plant apparatus, showing rotating output shaft affixed to a rotor and rotatably secured therewith, and with a turbine mounted for rotary motion in response to exiting combustion gas, and showing the gearbox connecting the impulse turbine and the output shaft, which allows the impulse turbine and the rotor to deliver energy on a common output shaft.

FIG. 2 is a side elevation view of a fully assembled power plant apparatus of the type first illustrated in FIG. I above, showing, from right to left, a starter motor, an electrical generator, a gear box, a shaft coupling, an inlet air plenum, the basic rotary ramjet engine, the impulse turbine casing, and the impulse turbine connecting gearbox.

FIG. 3 is a partial exploded perspective view showing in enlarged detail the basic rotary ramjet engine with an impulse turbine on the exhaust, and illustrating the additional use of steam cycle turbine blades on the impulse turbine.

FIG. 4 is a partially sectioned perspective view of a portion of the impulse turbine, illustrating the flow path for the hot exhaust gases through a heat exchanger, showing in additional detail the use of steam turbine blades having guide vanes at the inlet.

FIG. 5 is a perspective view of the impulse turbine assembly, seen as if assembled external to the rotary ramjet engine, wherein the impulse turbine is illustrated mounted on an annular disc, and showing the mounting hub, a ring gear, three planetary gears, a bearing plate, and sun gear configured for operable connection to and providing power at a splined output shaft.

FIG. 6 is an exploded perspective of an alternate embodiment of an impulse turbine assembly, provided in a hot end drive configuration, wherein all shaft power developed by the engine is delivered through the hot end output shaft.

FIG. 7 is a cross-sectional view of a planetary gear assembly for the impulse turbine, showing the center body housing with internal ring gear, three planetary gears, the central sun gear, and various bearing and lubrication details.

FIG. 8 is an exploded perspective, illustrating the various components of the impulse turbine assembly, including the annular rotor with turbine blades thereon, the drive shaft, a center body housing with internal ring gear, three planetary gears, a central sun gear, an external bearing cover plate, as well as the mounting hardware for affixing the bearing.

FIG. 9 is a force diagram showing the tangential and axial flow components of the exhaust flow of the rotary ramjet engine.

FIG. 10 illustrates the design parameters for the impulse turbine blade, with respect to swirl velocity and the inlet and outlet velocities through the turbine.

In the drawings, identical structures shown in the several figures will be referred to by identical reference numerals without further mention thereof.

### DETAILED DESCRIPTION

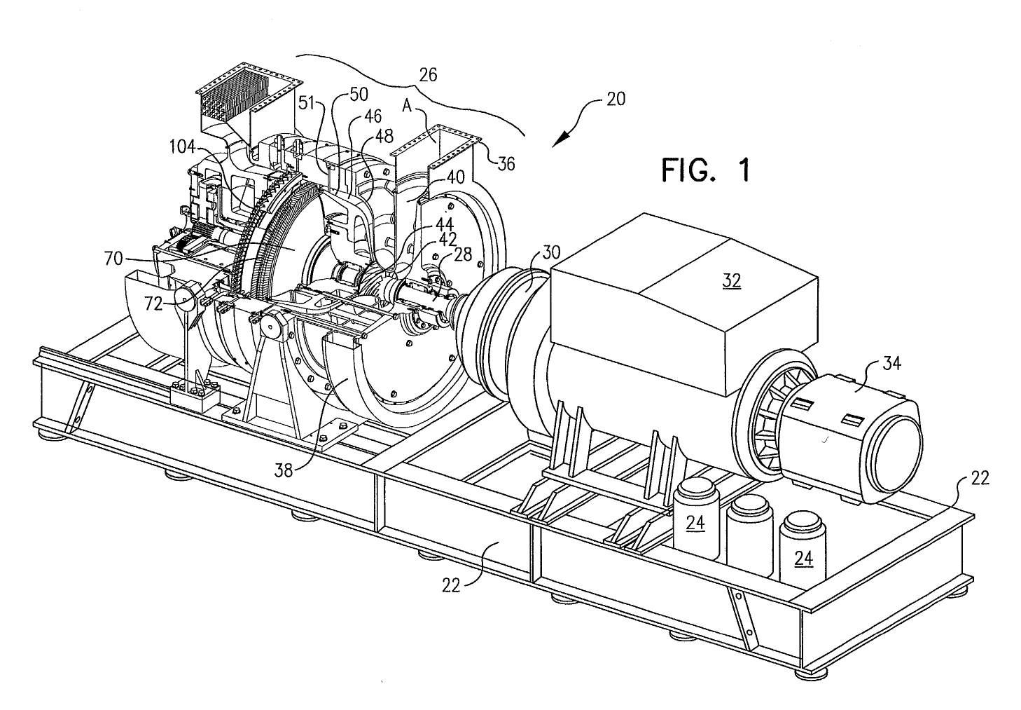

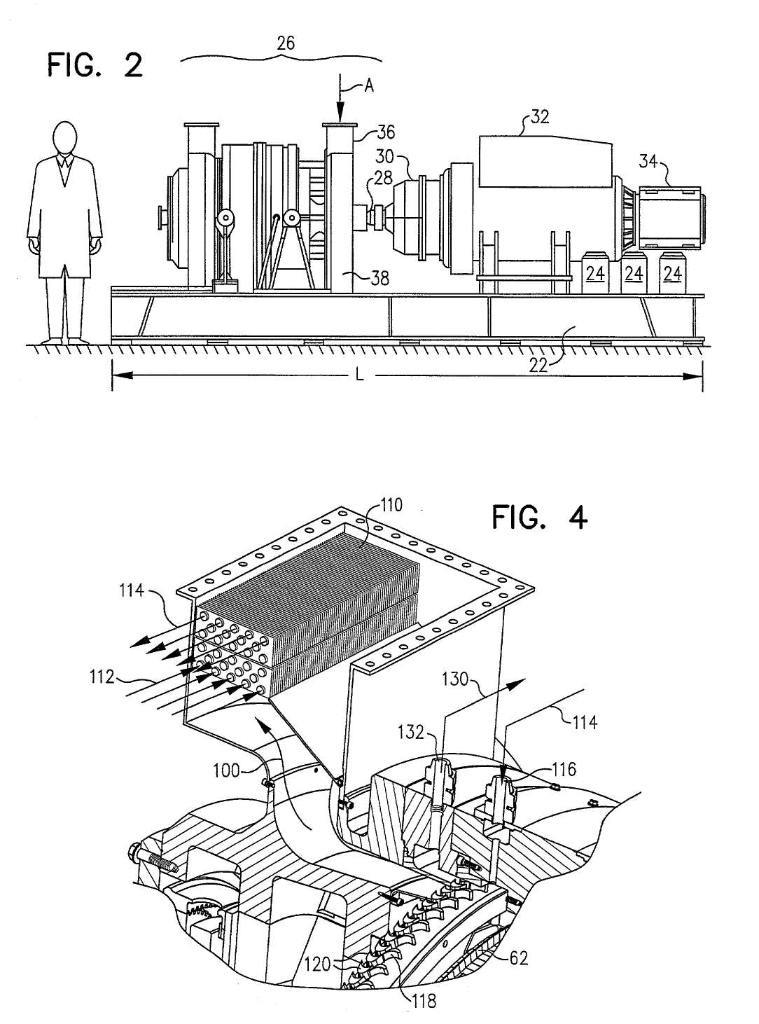

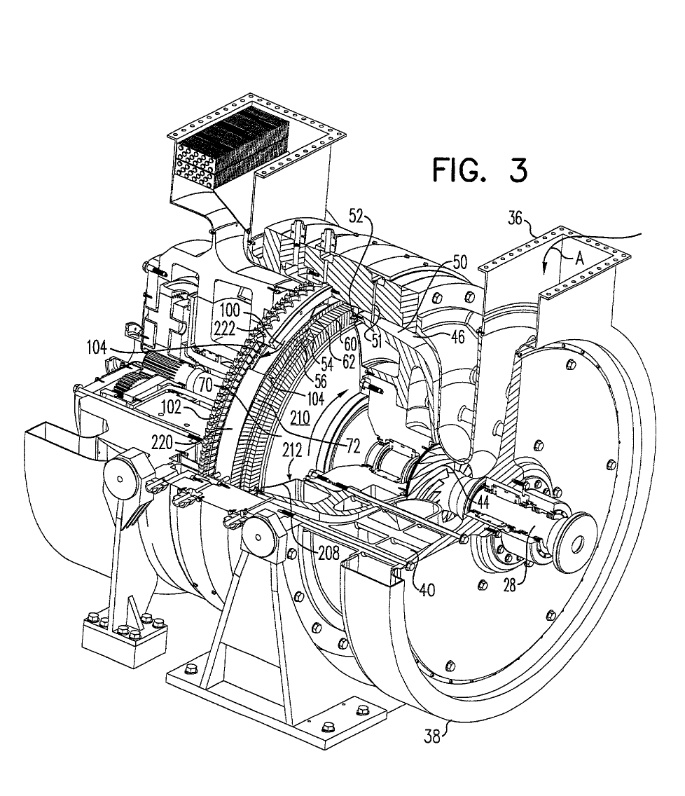

A perspective overview of an exemplary compact electrical generator set 20 is provided in FIG. 1. Components shown include the rail frame skid 22 with integral lubrication oil reservoir and adjacent lube oil pumps 24, the compact rotary ramjet engine 26 with output shaft 28, a gearbox 30, an electrical generator 32, and a starter motor 34. Inlet air as indicated by reference letter A is supplied via inlet duct 36 to a circumferential inlet air supply plenum 38 and thence through a substantially radial air inlet 40 for supply to a pre-swirl compressor inlet 42. From compressor inlet 42 a pre-swirl compressor 44 provides compression of the inlet air A. In one desirable configuration, about 1.0 psig of pressure, more or less, is developed. As better seen in FIG. 3, the compressed inlet air is allowed to decelerate in a diffuser portion 46 of pre-swirl compressor outlet duct 48, to build a reservoir of low velocity pressurized inlet air. Subsequently, converging portion 50 of outlet duct 48 convects inlet air to the primary fuel injectors 51. Then, the resultant fuel air mixture is deflected by inlet guide vanes 52 (of which only one guide vane 52 in the guide-vane row is shown in FIGS. 1 and 3 ) to provide both axial and tangential ramjet inlet velocities as required to produce, at design conditions, a negligible inflow angle of attack at the leading edge 54 of the ramjet inlet centerbody 56.

The supersonic ramjet inlet utilizes the kinetic energy inherent in the air mass or fuel/air premix due to the relative velocity between the ramjet inlet and the supplied air or fuel/air premix stream, to compress the inlet air (or, alternately, the inlet fuel/air mixture), preferably via an oblique shock wave structure. As illustrated herein, in order to carry out reliable, thorough combustion in the combustion chamber 72, the inlet stream is compressed utilizing a shock wave flow pattern operating with compression primarily laterally with respect to the plane of rotation of the rotor 70, to compress the inlet fuel/air mix between the inlet centerbody 56 and adjacent inlet 60 and outlet 62 strake structures. In the rotary ramjet engine 26 shown herein, compression and combustion is preferably achieved utilizing a small number of ramjets, (normally expected to be in the range from 2 to 5 total, with accompanying inlet and outlet strakes), and within an aerodynamic duct formed by the spirally disposed, or more specifically, helically disposed inlet 60 and outlet 62 strakes, as opposed to a traditional gas turbine or other axial flow compressor which utilizes many rotor and stator blades.

In order to obtain the proper conditions for combustion while minimizing undesirable products of combustion, the fuel and combustion air are preferably premixed prior to feed to the ramjet inlet. As illustrated in FIG. 3, fuel injectors 51 add necessary amounts of fuel to an inlet fluid entering through diffuser 48. The inlet fluid may be either a fuel free oxidant containing stream, or may contain some high value fuel such as hydrogen, or some low value fuel, such as coal bed methane, coal mine purge gas, landfill methane, biomass produced fuel gas, sub-quality natural gas, or other low grade fuels. In order to carry out the actual combustion step in an operationally reliable manner, the velocity of the compressed inlet fuel/air mixture must be high at the intermixing point between the combustion chamber and the delivery point of the combustible fuel/air mixture, so that flashback of the flame front from the combustor toward the inlet is avoided. In the rotary ramjet engine 26 described herein, the residence time in the diffuser is too short, and the total pressure too low, to initiate an auto-ignition process. Further, by the time the premix is compressed and heated, the in-flowing fluid has substantially entered the combustion chamber, and thus ignition or detonation is substantially avoided in this engine design, unlike, for example the situation in a conventional gas turbine compressor when ingesting an air stream having fuel therein.

In order to stabilize the combustion process downstream of the rear wall 104 of inlet centerbody 56, the velocity through the combustion chamber 72 is substantially reduced by providing a combustion chamber 72 having larger flow area than provided by the inlet ducts thereto, i.e., the passageways D between the inlet centerbody 56 and the inlet 60 and outlet 62 strakes. High-speed exhaust gas exiting the combustor 72 propels the rotor 70 at the desired rim speed under design load conditions. Accordingly, in the ramjet configuration illustrated, the acceleration and deceleration of the inlet fluid, and the acceleration and deceleration of the outlet combustion gases, is accomplished efficiently.

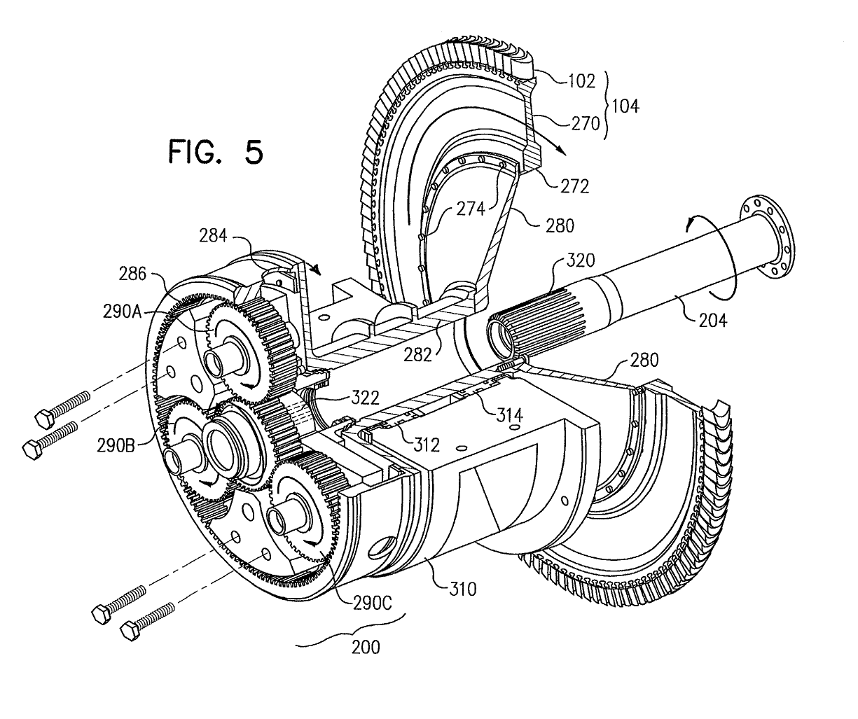

As illustrated in FIGS. 1, 3, and 4, the hot gas products of combustion, as indicated by reference arrow 100, after discharge from the combustion chamber 72 flow through a ramjet outlet nozzle, and thence along the outlet strake 62, and are directed, preferably at low pressure but still containing axial and tangential swirl kinetic energy, to exhaust gas blades 102 in an impulse turbine 104, for extraction of the kinetic energy based on the overall swirl energy inherent in such exhaust gas products 100. Finally, for enhanced efficiency, the hot exhaust gases 100 may be further utilized by capturing thermal energy therein by being directed to an exhaust heat exchanger 110 to heat condensate 112 and produce high pressure steam 114. The high pressure steam 114 is directed through high-pressure steam supply ports 116 and thence through steam inlet vanes (nozzles) 118, preferably fixed in orientation, and thence into the steam buckets 120 on top of the exhaust gas turbine blades 102 in the impulse turbine 104, for added energy recovery. Subsequently, low pressure steam 130 is exhausted from the impulse turbine 104 via steam discharge ports 132 and is directed to a condenser and then pumped (conventional components not illustrated) to the exhaust heat recuperater, i.e., heat exchanger 110 for replenishment of the supply of high pressure steam 114, for supply to the high pressure steam supply ports 116 and thence through steam inlet vanes (nozzles) 118 mentioned above. Alternately, as depicted in FIGS. 5, 6, and 8, the use of a steam bucket 120 and related steam system components in connection with the impulse turbine 104 may be omitted, and in such case, thermal energy may still be recovered for external use in a cogeneration system.

Also evident in FIGS. 5, 6, 7, and 8 is the use of a planetary gear systems for transmitting the power captured by the turbine. It is desirable to match the tangential speed of rotor 70 and the desired rotational speed of turbine 104 where the turbine 104 is not directly affixed to, and turns at a different speed than rotor 70.

The exemplary embodiment of the ramjet engine generator set 20 as just described, operating at the exemplary conditions as described, typically has a net system efficiency at rated power is of at least 32%, and more preferably, of at least 35%, when operating using an impulse turbine for recovery of kinetic energy from hot exhaust gases, but without a steam turbine. When a steam turbine is employed, the net system efficiency at rated power output is preferably at least 38%. More preferably, the net system efficiency at rated power output of such a system configuration is at least 45%, where the quality of generated steam permits.

It should also be noted that in order to minimize aerodynamic drag and efficiently operate the outer portions of the rotor 70 at supersonic tangential velocities, means can be provided to reduce drag of the rotor 70. This can take the form of a fixed housing 208 with a small interior gap G between the rotor surface 210 and an interior 212 of housing 208. Such rotor drag minimizing techniques are taught in U.S. Pat. No. 5,372,005, issued Dec. 14, 1994 to Lawlor, which patent is incorporated herein in its entirety by this reference. Alternately, vacuum means can be utilized to remove air from adjacent the rotor 70, in order to minimize drag.

With respect to the exhaust gas blades 102 of the impulse turbine 104, the exhaust flow typically has a high degree of recoverable kinetic energy from the exhaust gas swirl. This is because the exhaust gas flow has been expanded, in leaving the ramjet nozzle, to near atmospheric pressure. Thus, a preferred turbine stage for extracting the remaining energy is designed to capture and convert the swirl velocity into useable mechanical power, and preferably avoids additional complexity of appreciable pressure decrease or expansion of the exhaust gas flow stream. In other words, it is preferable to utilize a substantially constant-pressure or impulse type turbine for this application. However, it is to be understood that it is not required that the turbine be a pure impulse turbine, and indeed, in certain applications, utilization of at least some energy in the exhaust stream via pressure-expansion is permissible, within the teaching provided herein, as will be understood by those of ordinary skill in the art and to whom this disclosure is addressed. But, according to the design illustrated, the aero-thermodynamic losses resulting from the three dimensional flow field, as confined by inner 220 wall and outer wall 222, relative to the rotating blade passage opening 230 (see FIG. 10), has been calculated using a computer program based on one-dimensional flow utilizing a loss library based on the methodology of Ainly and Mathieson, as set forth in their work entitled “An Examination of the Flow and Pressure Losses in Blade Rows of Axial Flow Turbines”, Aeron, Research Council R&M No. 2891, 1955. The exhaust gas turbine blade design is based on the approach of Stratford and Sansome, as set forth in their work “Theory and Tunnel Test for Rotor Blades for Supersonic Turbines,” by the Deputy Controller, Aircraft Ministry of Aviation, R&M No. 3275, 1960, which was also issued as N.G.T.E Report No. 245-A.R.C, 22,537. In this exemplary embodiment, the entry region curvature is one-half of the channel passage curvature, and the exit region curvature is also one-half of the channel passage curvature. This exemplary embodiment produces smooth, substantially vortex-free flow in the channel between turbine blades 102. Additionally the flow through any cascade of blades experiences aerodynamic losses that can be measured and evaluated as differences between the inlet and exit total pressures, divided by the exit dynamic pressure which is equal to the difference between the exit total and static pressures. Thus, using the loss library data, the design computer program calculates the losses produced in the flow stream due to the blade 102 and annulus geometry. The profile or skin friction loss is determined on a normalized basis, and then corrected for effects of solidity, Reynolds number, entrance Mach conditions, incidence condition, and passage diffusion. Leakage of flow around the blade 102 that produces an exchange of momentum with the main flow stream causes an efficiency loss, and has been evaluated, as well as the secondary loss due to the circulatory flow within the blade channel caused by the annulus containing the flow.

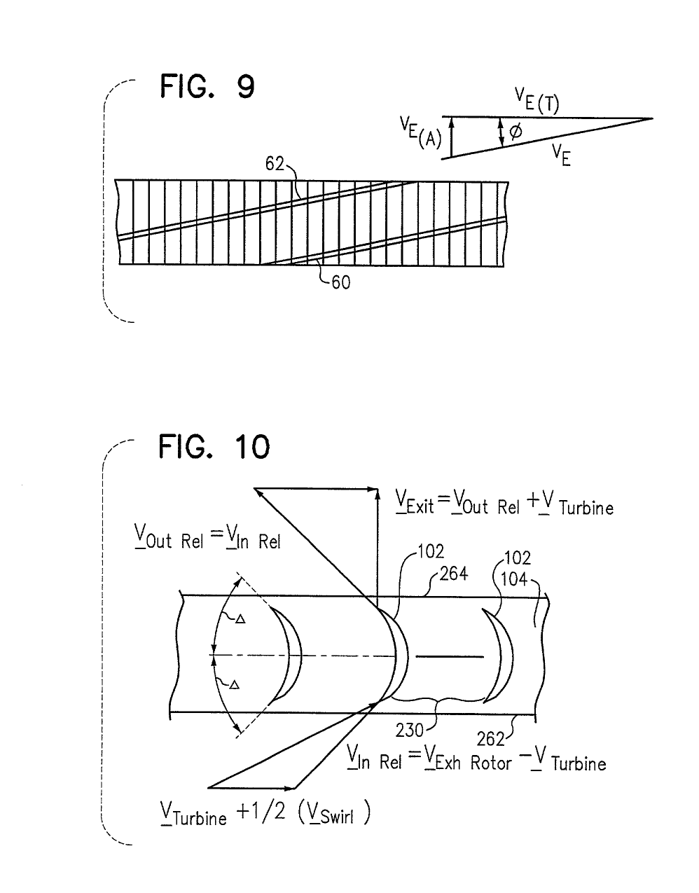

Turning now to FIG. 9, a velocity triangle for the ramjet hot exhaust gases is illustrated. At the outlet, the angle theta (φ) which the exhaust gas stream proceeds at a velocity Of V_{E} is equal to the inverse tangent of ratio of [V_{E(A)}/V_{E(T)}], where the axial velocity of the exhaust gas is V_{E(A)}, and where the tangential velocity of the exhaust gas is V_{E(T).}:

$$( φ ) = {tan}^{- 1} \frac{{V}_{E ( A )}}{{V}_{E ( T )}} :$$

The impulse turbine 104 is important because of the additional energy recovery and overall system efficiency improvement provided. As an example, for a ramjet rotor wherein the rim 250 of rotor 70 has a Mach number of 2.75, the ramjet flowpath would develop approximately 303 horsepower (gross, before system losses) of mechanical shaft power per pound mass flow of exiting the ramjet. Then, in the impulse turbine, assuming an efficiency of 80 percent, the impulse turbine could extract 118 horsepower per pound mass from the ramjet exhaust flow. Of course, these numbers may vary for any specific design.

In FIG. 10, a velocity triangle for an exemplary impulse turbine 104 blade 102 arrangement is illustrated. A desired blade 102 extends radially outward from a impulse turbine 104 annular rotor 260, having an upstream rim edge 262 and a downstream rim edge 264. When operating on design velocity, the impulse turbine blade 102 extracts substantially the entire swirl energy from the ramjet exhaust. After passage through the impulse turbine, exhaust gas discharge would be low-speed axial flow with very little remaining kinetic energy.

In order to achieve the desired energy recovery, the impulse turbine 104 needs to rotate in the opposite direction, and at lower speed, than the ramjet rotor 70. This configuration is advantageously achieved with a planetary gear set 200 incorporated into the rotary ramjet engine 20. This gear configuration achieves the required reversal of rotation, while coupling the power output from the impulse turbine 104 directly to an output shaft portion 204 that is directly affixed to rotor 70 of the ramjet engine 20. As better illustrated in FIG. 5, the annular disc portion 270 of the impulse turbine 104 has affixed thereto, preferably at or near the interior edge portion 272 of the annular disc 270 and preferably by suitable fasteners 274, a mounting hub 280 with mounting shaft sleeve 282 that connects to a tubular cylindrical rotating housing 284 having an interior ring gear 286. The ring gear 286 in turn drives planetary gears 290A, 290B, and 290C, which are securely affixed to shafts 292A, 292B, and 292C, respectively, and provisioned with bearing assemblies 294A, 294B, and 294C. The planetary gears 290A, 290B, and 290C reverse the force direction, and increase the angular velocity from the ring gear, and transfer rotational energy to the sun gear 300, so as to match the pre-selected speed of the high speed output shaft portion 204. For example, in one embodiment, it is desirable to operate the impulse turbine at a rotational speed of about 7000 rpm to match a high-speed output shaft rotational speed of 17,205 rpm. For such design parameters, then, a gear ratio of about 2.5:1 provides the appropriate speed increase from impulse turbine to high-speed output shaft 204. Other gear ratios may be selected for other conditions, such as from a ratio of about 2:1, of up to a ratio of as much as 3.5:1.0.

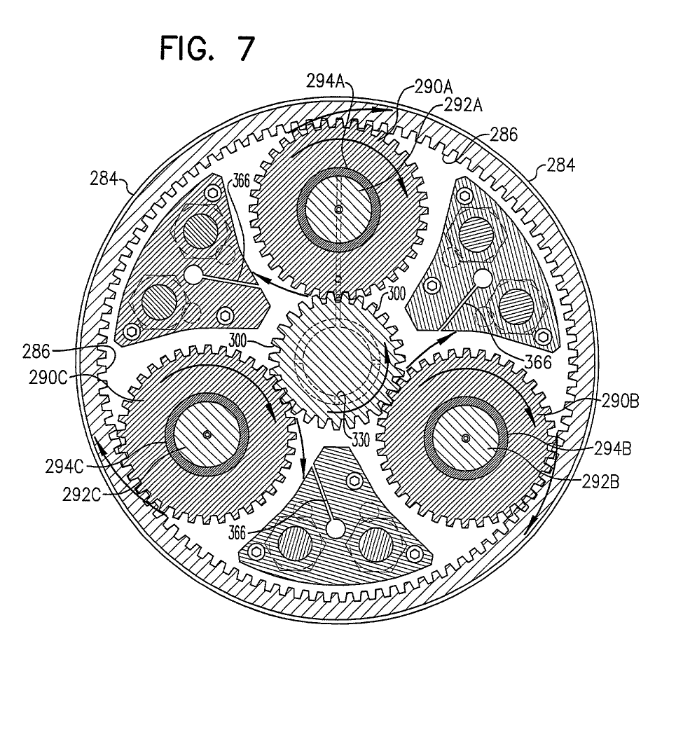

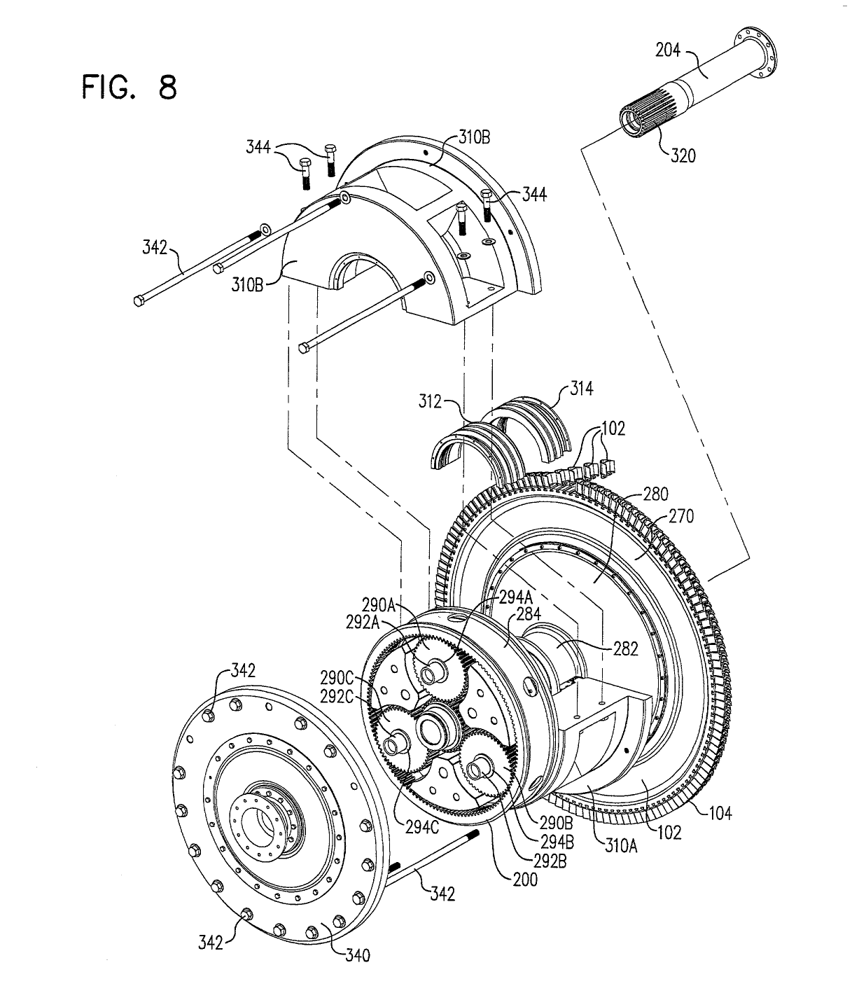

Additional details are illustrated in FIGS. 5, 7, and 8. First, in FIG. 5, fixed (non-rotating) split casing portions 310A and 310B are provided, with internal bearings 312 and 314 to rotationally accommodate and support the mounting shaft sleeve 282. The high-speed shaft 204 is ideally provided with splines 320 that are adapted for meshing engagement with a matching spline set 322 in the interior of sun gear 300. Also, as suggested in FIG. 7, a passageway 330 design may be utilized in the interior of sun gear 300 as a lube oil passage. In any case, as seen in FIG. 8, a cover 340 is provided, which is affixed to the split casing portions 310A and 310B via suitable fasteners 342. Casing portions 310A and 310B are joined by fasteners 344.

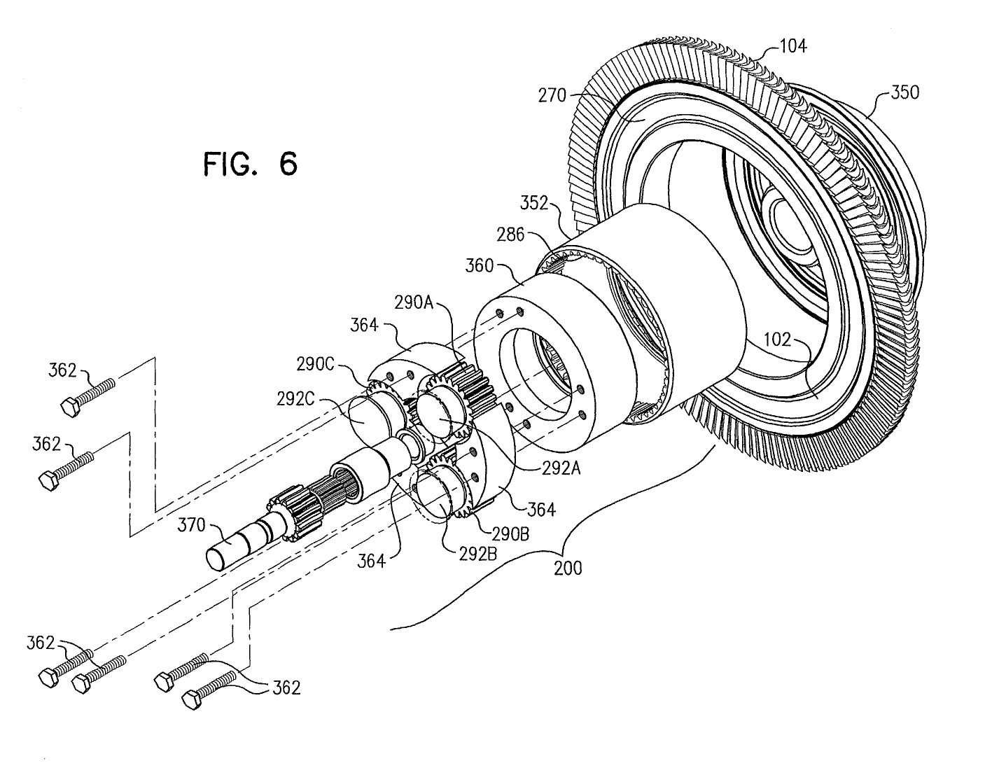

Note by comparison of FIGS. 5 and 6 that several embodiments of the gear set design are feasible. In FIG. 5, the configuration just described above is set forth. However, in FIG. 6, an alternate configuration is provided utilizing a center-hub 350 for attachment between annular rotor 270 of the impulse turbine 104 and the cylindrical tubular housing 352 containing ring gear 286. Also, a backing plate 360 is provided for attachment via fasteners 362 of mounting blocks 364 containing lubrication conduits 366 (see FIG. 7). Returning to FIG. 6, note that in this embodiment, the provision of a hot end output shaft portion 370 is illustrated. In this way, instead of transmitting output power out through the intake or “cold end” of the engine 20, the output is transmitted out of the engine through the exhaust (or hot end) of the system.

Although only a few exemplary embodiments and aspects of this invention have been described in detail, various details are sufficiently set forth in the drawing and in the specification provided herein to enable one of ordinary skill in the art to make and use such exemplary embodiments and aspects which need not be further described by additional writing in this detailed description. Importantly, the designs described and claimed herein may be modified from those embodiments provided without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations of the present invention are possible in light of the above teachings. It is therefore to be understood that within the scope of the appended claims, the invention may be practiced otherwise than as specifically described herein. Thus, the scope of the invention, as set forth in the appended claims, and as indicated by the drawing and by the foregoing description, is intended to include variations from the embodiments provided which are nevertheless described by the broad interpretation and range properly afforded to the plain meaning of the claims set forth below.

1. A ramjet engine comprising, in combination:
(a) rotating components, in series flow:
(1) a rotary ramjet, said rotary ramjet comprising (A) a rotor turning at a first rotating speed, and (B) at least one rotary combustion chamber portion comprising (i) a ramjet compression inlet (ii) a flame holder, and (iii) an outlet nozzle on a rotor;
(2) a turbine turning at a second rotating speed;
(b) adjacent static housing structure defining
(1) an engine casing (A) having an inner wall surface defining a static combustion chamber portion, (B) said rotary and said static combustion chamber portions adapted to work together to receive fuel from a fuel supply and inlet air from said inlet air compressor to burn said fuel and produce a hot exhaust gas flow to impart rotary motion to said rotor; and
(2) an external turbine casing peripherally confining said impulse turbine, said impulse turbine adapted to receive said hot exhaust gas flow and turn an output housing;
(c) a gear set, said gear set driven by said output housing;
(d) an output shaft portion, said output shaft portion operably connected to said gear set for delivery of energy from said impulse turbine.

2. The apparatus as set forth in claim 1, wherein said gear set and said output shaft portion are adapted to operably connect said impulse turbine and said rotor for output of mechanical power from said impulse turbine to said rotor.

3. The apparatus as set forth in claim 1, wherein said first rotating speed is greater than said second rotating speed.

4. The apparatus as set forth in claim 1, wherein the ratio of said first rotating speed to said second rotating speed is in the range from approximately 2:1 to approximately 3.5:1.

5. The apparatus as set forth in claim 1, wherein said rotor rotates in a first direction of rotation, and wherein said impulse turbine rotates in a second direction of rotation, and wherein said first and said second directions of rotation are opposite.

6. The apparatus as set forth in claim 1, wherein said gear set comprises a planetary gear system having a ring gear in said output housing, a plurality of planetary gears, and a sun gear, and wherein said sun gear is affixed to said output shaft portion.

7. The apparatus as set forth in claim 1, wherein said hot exhaust gases exiting said ramjet combustor have a swirl velocity component, and wherein said impulse turbine comprises a set of blades adapted to react against, and capture kinetic energy in said hot exhaust gases, and in so doing substantially reduces any swirl velocity component in exhaust gases exiting said impulse turbine.

8. The apparatus as set forth in claim 1, wherein said impulse turbine further comprises a plurality of steam buckets, said steam buckets adapted to capture kinetic energy from a steam feed.

9. The apparatus as set forth in claim 8, wherein said apparatus comprises a plurality of fixed inlet guide vanes, said fixed inlet guide vanes located, flow-wise, upstream of said steam buckets.

10. The apparatus as set forth in claim 9, further comprising steam injection ports, said steam injection ports adapted to provide high pressurized steam to said fixed inlet guide vanes for redirection to said steam buckets on said impulse turbine.

11. The apparatus as set forth in claim 10, wherein said apparatus further comprises, downstream of said impulse turbine, (a) a steam receiving duct, said steam receiving duct spaced downstream from said steam buckets, and (b) a low pressure steam outlet.

12. The apparatus as set forth in claim 1, wherein net system efficiency at rated power is at least 30%.

13. The apparatus as set forth in claim 1, wherein net system efficiency at rated power is at least 35%

14. The apparatus as set forth in claim 12, or in claim 13, wherein net system efficiency at rated power output is at least 38%.

15. The apparatus as set forth in claim 12, or in claim 13, wherein net system efficiency at rated power output is at least 45%

16. The apparatus as set forth in claim 1, further comprising a heat recovery steam generator, said heat recovery steam generator adapted to receive and cool said hot exhaust gas flow and to produce pressurized steam therefrom.

17. The apparatus as set forth in claim 1, further comprising a first electrical generator, said first electrical generator driven by said rotor shaft.

18. The apparatus of claim 1 wherein said rotary ramjet operates at a speed of at least Mach 1.5.

19. The apparatus of claim 1 wherein said rotary ramjet operates at a speed between Mach 1.5 and Mach 3.0.

20. The apparatus of claim 1 wherein each of said rotary ramjet operates at about Mach 2.5 or more.

21. The apparatus of claim 1, wherein said apparatus operates at about Mach 2.75.

22. A ramjet engine comprising, in combination:
(a) rotating components, in series flow:
(1) a rotary ramjet means, said rotary ramjet means comprising (A) a rotor means turning at a first rotating speed, and (B) at least one rotary combustion chamber portion means comprising (i) a ramjet compression inlet means (ii) a flame holder means, (iii) an outlet nozzle means on a rotor means, and (iv) an output shaft means;
(2) a turbine means turning at a second rotating speed;
(b) adjacent static housing means defining
(1) an engine casing means (A) having an inner wall surface means defining a static combustion chamber portion means, (B) said rotary and said static combustion chamber portion means adapted to work together to receive fuel from a fuel supply and inlet air from said ramjet compression inlet means to burn said fuel and produce a hot exhaust gas flow to impart rotary motion to said rotor means; and
(2) an external turbine casing means peripherally confining said impulse turbine means, said impulse turbine means adapted to receive said hot exhaust gas flow and turn an output housing means;
(c) a gear set, said gear set driven by said output housing means;
(d) an output shaft portion, said output shaft portion operably connected to said gear set for delivery of energy from said impulse turbine means.

23. The apparatus as set forth in claim 22, wherein said hot exhaust gases exiting said ramjet combustor means have a swirl velocity component, and wherein said impulse turbine means comprises a set of blades adapted to react against, and capture kinetic energy in said hot exhaust gases, and in so doing substantially reduces any swirl velocity component in exhaust gases exiting said impulse turbine means.

24. The apparatus as set forth in claim 22, wherein said impulse turbine means further comprises a plurality of steam buckets, said steam buckets adapted to capture kinetic energy from a steam feed.

25. The apparatus as set forth in claim 24, wherein said apparatus comprises a plurality of fixed inlet guide vanes, said fixed inlet guide vanes located, flow-wise, air upstream of said steam buckets.

26. The apparatus as set forth in claim 25, further comprising steam injection ports, said steam injection ports adapted to provide high pressurized steam to said fixed inlet guide vanes for redirection to said steam buckets on said impulse turbine means.

27. The apparatus as set forth in claim 26, wherein said apparatus further comprises, downstream of said impulse turbine means, (a) steam receiving duct means, said steam receiving duct means spaced downstream from said steam buckets, and (b) a low pressure steam outlet.

28. The apparatus as set forth in claim 22, wherein net system efficiency at rated power is at least 30%.

29. The apparatus as set forth in claim 22, wherein net system efficiency at rated power is at least 35%

30. The apparatus as set forth in claim 26, or in claim 27, wherein net system efficiency at rated power output is at least 38%.

31. The apparatus as set forth in claim 26, or in claim 27, wherein net system efficiency at rated power output is at least 45%

32. The apparatus as set forth in claim 22, further comprising a heat recovery steam generator, said heat recovery steam generator adapted to receive and cool said hot exhaust gas flow and to produce pressurized steam therefrom.

33. The apparatus as set forth in claim 22, further comprising a first electrical generator, said first electrical generator driven by said output shaft means.

34. The apparatus of claim 22 wherein said rotary ramjet operates at a speed of at least Mach 1.5.

35. The apparatus of claim 22 wherein said rotary ramjet operates at a speed between Mach 1.5 and Mach 3.0.

36. The apparatus of claim 22 wherein each of said rotary ramjet operates at about Mach 2.5 or more.
